(19) United States
(12) Patent Application Publication
(10) Pub. No.: US 2026/0343029 A1
(43) Pub. Date: Oct. 29, 2026

(54) PROCESSING FILM GRAIN CHARACTERISTICS FOR MULTIPLE PICTURE RESOLUTIONS

(71) Applicant: QUALCOMM Incorporated, San Diego, CA (US)

(72) Inventors: Yong He, San Diego, CA (US); Shuai Zhao, Rancho Cordova, CA (US); Louis Joseph Kerofsky, San Diego, CA (US)

(21) Appl. No.: 19/652,581

(22) Filed: Apr. 20, 2026

Related U.S. Application Data
(60) Provisional application No. 63/794,868, filed on Apr. 25, 2025.

(51) Int. Cl. H04N 19/70; H04N 19/117; H04N 19/136; H04N 19/184; H04N 19/82

(52) U.S. Cl. CPC H04N 19/70; H04N 19/117; H04N 19/136; H04N 19/184; H04N 19/82

(57) ABSTRACT

An example device for processing video data includes: a memory configured to store video data; and a processing system implemented in circuitry and configured to: obtain a non-processing order nesting (PON)-nested supplemental enhancement information (SEI) message in a bitstream for a processing chain to be performed on video data of the bitstream; obtain a PON-nested SEI message in the bitstream for the processing chain; and perform the processing chain on the video data to form post-processed video data, wherein the processing system is configured to use contents of the non-PON-nested SEI message to perform one or more processing tasks of the processing chain without modifying the one or more processing tasks based on contents of the PON-nested SEI message.

This application claims the benefit of U.S. Provisional Application No. 63/794,868, filed Apr. 25, 2025, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for signaling and parsing multiple supplemental enhancement information (SEI) messages for a bitstream including video data. SEI messages may be nested in, e.g., processing order nesting (PON) SEI messages, and/or may be described by data of SEI processing order (SPO) SEI messages. This may allow for multiple different versions of the same type of SEI message to be included in the bitstream. Different versions of the same SEI message may correspond to different types of video data, e.g., different resolutions of the video data. One example of such a potentially nested SEI message is a film grain characteristics (FGC) SEI message, which may apply to a variety of different video resolutions. However, some devices (e.g., video decoders and/or post processing units) may not be configured to process nested SEI messages. Therefore, this disclosure describes techniques by which SEI messages may be provided in a video bitstream that may be nested or non-nested, so as to provide for backward compatibility for devices that are not configured to parse nested SEI messages.

In one example, a method of processing video data includes: obtaining a non-processing order nesting (PON)-nested supplemental enhancement information (SEI) message in a bitstream for a processing chain to be performed on video data of the bitstream; obtaining a PON-nested SEI message in the bitstream for the processing chain; and performing the processing chain on the video data to form post-processed video data, including using contents of the non-PON-nested SEI message to perform one or more processing tasks of the processing chain without modifying the one or more processing tasks based on contents of the PON-nested SEI message.

In another example, a device for processing video data includes: a memory configured to store video data; and a processing system implemented in circuitry and configured to: obtain a non-processing order nesting (PON)-nested supplemental enhancement information (SEI) message in a bitstream for a processing chain to be performed on video data of the bitstream; obtain a PON-nested SEI message in the bitstream for the processing chain; and perform the processing chain on the video data to form post-processed video data, wherein the processing system is configured to use contents of the non-PON-nested SEI message to perform one or more processing tasks of the processing chain without modifying the one or more processing tasks based on contents of the PON-nested SEI message.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a flowchart illustrating an example method of performing post-processing on decoded video data per techniques of this disclosure.

### DETAILED DESCRIPTION

Coding (encoding and decoding) of video data generally involves partitioning a picture of an image sequence into individual blocks, forming a prediction block for each block, and coding a residual block representing sample-by-sample differences between an original block and the prediction block. Prediction may be intra-frame (that is, within the frame including the current block being coded) or inter-frame (that is, from a different frame than the frame including the current block being coded).

Coded video data may be organized into network abstraction layer (NAL) units, which provide a “network-friendly” video representation addressing applications such as video telephony, storage, broadcast, or streaming. NAL units can be categorized as Video Coding Layer (VCL) NAL units and non-VCL NAL units. VCL units may contain data for the core compression engine and may include block and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and supplemental enhancement information (SEI) NAL units, among others. Parameter sets may contain sequence-level header information (in sequence parameter sets (SPS)) and infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) messages may contain information that is not necessary for decoding coded pictures of VCL NAL units, but may assist in processes related to decoding, display, error resilience, and other purposes. SEI messages may be contained in non-VCL NAL units. SEI messages are the normative part of some standard specifications, and thus, are not always mandatory for a standards-compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multi-view video coding (MVC). These example SEI messages may convey information on, e.g., extraction of operation points and characteristics of the operation points.

A standard may specify video usability information (VUI) and SEI messages used within a video bitstream. Versatile Supplemental Enhancement Information (VSEI), per ITU-T H.274 and ISO/IEC 23002-7, is an example of such a standard. The SEI mechanism enables encoders to include metadata in the bitstream that is not required for the correct decoding of sample values of output pictures, but can be used for various other purposes. Encoders can include any number of SEI NAL units in an access unit, and each SEI NAL unit may contain one or more SEI messages. Specifications and systems using VVC may require encoders to generate certain SEI messages or may define specific handling of particular types of received SEI messages.

Film grain synthesis technology can provide subjective quality benefits for certain video applications and can be used to effectively achieve improved video compression. A film grain parameterization process may be performed by a video encoder to determine film grain model parameter values. The video encoder may form a film grain characteristics (FGC) SEI message to include the film grain model parameter values. The video decoder may parse the film grain model parameter values and provide the film grain model parameter values to a film grain synthesis process that generates simulated film grain and blends the grain with decoded video to output decoded video with simulated film grain.

This disclosure recognizes that film grain characteristics may be related to a certain resolution of video data, and that it may be important that the SEI message signals the intended resolution. Applying FGC with parameters intended for use at a full resolution to video data at a lower resolution, then upsampling the lower resolution video data to the full resolution, may result in poor quality video data. Using parameters designed for lower resolution and upsampling may achieve better results, but not as good as when film grain is overlaid after upsampling.

This disclosure recognizes that problems may arise from coding multiple FGC SEI messages for different resolutions in the same bitstream, because some video decoders and post-processors may ignore extension picture resolution parameters and may not be capable of determining which of the FGC SEI messages is appropriate for a particular set of video data.

JVET-AL0339 states, “Film grain modelling information for more than one spatial resolution can be indicated in the same bitstream by including the FGC SEI messages of different spatial resolutions into different processing chains and including FGC SEI messages in [processing order nesting] PON SEI messages so that an FGC SEI message for a particular spatial resolution does not cancel the persistence of another FGC SEI message for another spatial resolution.” However, this disclosure recognizes that conventional constraints do not allow co-existence of a non-PON-nested FGC SEI message and a PON-nested FGC SEI message.

JVET-AL0339 also states, “The use of the film grain characteristics SEI message in combination with the dynamic picture resolution changes supported by sps_res_change_in_clvs_allowed_flag equal to 1 was not studied at the time of development of the original version of this Specification. An encoder can indicate the width and height of the picture for which the film grain modelling information is indicated with fg_pic_width_in_luma_samples and fg_pic_height_in_luma_samples, respectively.”

This disclosure describes techniques related to FGC, SEI processing order (SPO), and processing order nesting (PON) SEI messages that may enable multiple FGC SEI messages for dynamic picture resolution changes or matching various resolutions at end devices. Thus, multiple FGC SEI messages may be included in a bitstream, and may be matched to a corresponding resolution of a variety of different picture resolutions. In this manner, these techniques may improve efficiency of coding the bitstream and make the bitstream applicable to a wide variety of end devices, without needing to be matched to a specific end device.

Conventional SPO constraints specify that when an FGC SEI message is present with fg_characteristics_persistence_flag equal to 1 that is not a PON-nested SEI message, there shall not be an associated film grain characteristics SEI message in the same Coded Layer Video Sequence (CLVS) that is a PON-nested SEI message. These conventional constraints would not allow a non-PON-nested FGC carried in the bitstream for existing implementations with the additional PON-nested FGC SEI messages carried in the SPO and PON SEI messages for multiple resolutions.

Per techniques of this disclosure, an FGC SEI message, or other such SEI message for post processing video data, may be carried in a bitstream for existing implementations that cannot properly handle PON SEI messages and/or cannot parse FGC extension bits. Additionally or alternatively, one or more FGC SEI messages with picture resolution extensions may be indicated by one or more SPO SEI messages and may be included in PON SEI messages as PON-nested SEI messages for implementations that support such PON SEI messages, e.g., those conforming to VSEI v4 and later versions. In this manner, the techniques of this disclosure may be used by video decoders and/or post processing units to correctly determine parameters for, e.g., post processing video data, regardless of whether the video decoders/post processing units are capable of parsing PON-nested SEI messages and/or SPO SEI messages.

Video applications may use supplemental enhancement information (SEI) messages, such as film grain characteristics (FGC) SEI messages, to provide metadata for post-processing video data. Film grain characteristics generally relate to a certain spatial resolution of video data. Problems may arise when coding multiple FGC SEI messages for different resolutions in the same bitstream. For example, some video decoders and post-processors ignore extension picture resolution parameters and cannot determine which of the FGC SEI messages is appropriate for a particular set of video data. Furthermore, conventional processing order nesting (PON) constraints do not allow coexistence of a non-PON-nested SEI message and a PON-nested SEI message. Consequently, a conventional bitstream cannot carry both a non-PON-nested FGC SEI message for backward compatibility with traditional decoders and a PON-nested FGC SEI message for newer decoders capable of matching the FGC SEI message with the picture resolution. Applying FGC with parameters intended for use at a full resolution to video data at a lower resolution, then upsampling the lower resolution video data to the full resolution, may result in poor quality video data.

The techniques of this disclosure enable coexistence of non-PON-nested SEI messages and PON-nested SEI messages for a common processing chain. In particular, per the techniques of this disclosure, a device may obtain a non-PON-nested SEI message in a bitstream for a processing chain to be performed on video data of the bitstream, obtain a PON-nested SEI message in the bitstream for the processing chain, and perform the processing chain on the video data to form post-processed video data. To perform the processing chain, the device may use contents of the non-PON-nested SEI message to perform one or more processing tasks of the processing chain without modifying the one or more processing tasks based on contents of the PON-nested SEI message. For instance, the device may maintain the persistence of the non-PON-nested SEI message even if the PON-nested SEI message includes data canceling persistence.

As an example, a single bitstream may carry a non-PON-nested FGC SEI message intended for traditional decoders that do not support SPO or PON SEI messages. Within the same bitstream, a first SPO SEI message may indicate a first PON-nested FGC SEI message having parameters configured for 1080p resolution video data, and a second SPO SEI message may indicate a second PON-nested FGC SEI message having parameters configured for 4K resolution video data. A newer decoder capable of determining intended resolutions can parse the appropriate PON-nested FGC SEI message matching the decoded picture resolution, while traditional decoders can safely process the non-PON-nested FGC SEI message.

By restricting dependency constraints such that the semantics and effect of an SEI message that is not a PON-nested SEI message do not depend on any PON-nested SEI message within a processing chain, a single bitstream can support both traditional and picture resolution-adaptive processing. Traditional decoders can correctly parse the non-PON-nested SEI messages, while newer decoders can use the PON-nested SEI messages for specific resolutions. The described techniques may therefore improve coding efficiency and reduce bandwidth by allowing a single bitstream to serve a variety of end devices with different resolution capabilities without degrading subjective visual quality of the resulting decoded and post-processed video data.

Coding (encoding and decoding) of video data generally involves partitioning a picture of an image sequence into individual blocks, forming a prediction block for each block, and coding a residual block representing sample-by-sample differences between an original block and the prediction block. Prediction may be intra-frame (that is, within the frame including the current block being coded) or inter-frame (that is, from a different frame than the frame including the current block being coded).

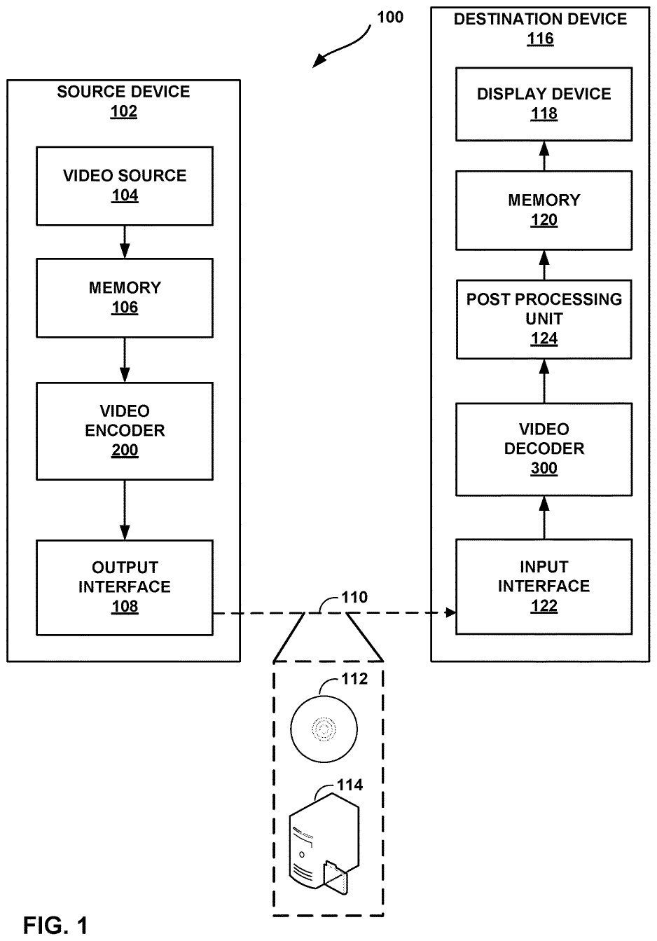

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, post processing unit 124, memory 120, and display device 118. In accordance with this disclosure, video encoder 200 of source device 102 and video decoder 300 of destination device 116 may be configured to apply the techniques for processing film grain characteristics (or other potentially nested SEI messages), e.g., for multiple picture resolutions. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for processing film grain characteristics (or other potentially nested SEI messages), e.g., for multiple picture resolutions. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. Example audio codecs include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Audio.

Video encoder 200 and video decoder 300 each may be implemented as any of a variety of suitable encoder and/or decoder circuitry of a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that include processing film grain characteristics (or other potentially nested SEI messages), e.g., for multiple picture resolutions.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may have N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

Furthermore, video encoder 200 may generate SEI messages representing, e.g., post processing to be performed on video data of the bitstream by video decoder 300. Such SEI messages may include, for example, film grain characteristics (FGC) SEI messages or other such messages, which may be nested in a PON SEI message.

Per the techniques of this disclosure, conventional constraints related to SEI messages, such as FGC SEI messages or other potentially nested SEI messages, may be modified as below to enable multiple FGC SEI messages for multiple intended picture resolutions:
It is a requirement of bitstream conformance that the semantics and effect of an SEI message that is not a PON-nested SEI message in a processing chain shall not depend on any PON-nested SEI message in the same processing chain.

Alternatively, this constraint may be modified as follows, per techniques of this disclosure:
It is a requirement of bitstream conformance that the semantics and effect of an SEI message that is not a PON-nested SEI message indicated by an SPO SEI message shall not depend on any PON-nested SEI message indicated by the same SPO SEI message.

Thus, video encoder 200 may construct non-PON-nested SEI messages such that the non-PON-nested SEI messages do not depend on any PON-nested SEI message in the same processing chain. Additionally or alternatively, video encoder 200 may construct non-PON-nested SEI messages that are not part of a PON-nested SEI message indicated by an SPO SEI message such that these non-PON-nested SEI messages do not depend on any PON-nested SEI message indicated by the SPO SEI message. By requiring that the semantics and effects of a non-PON-nested SEI message not depend on a PON-nested SEI message indicated by the same SEI processing order (SPO) SEI message, the techniques of this disclosure better resolve ambiguities present in prior standards. Specifically, the above-described constraint better ensures that two independent SEI messages are explicitly indicated by the same SPO SEI message to be processed in the constrained manner. This prevents video decoder 300 or post processing unit 124 from unpredictably applying persistence cancellations or modifications across unrelated processing chains or unspecified SPO SEI messages, thereby ensuring deterministic post-processing behavior for varying picture resolutions. As such, if video decoder 300 and/or post processing unit 124 are not configured to determine an appropriate picture resolution parameter or to parse PON-nested SEI messages and/or SPO SEI messages, video decoder 300 and/or post processing unit 124 may nevertheless obtain and parse a non-PON-nested SEI message to correctly determine how to process the video data.

Consequences of these constraint changes per this disclosure may include any or all of the following specific constraints, in which an associated SEI message is considered to be an SEI message that affects the semantics or effect of a particular SEI message:
When a neural-network post-filter characteristics SEI message is present with a particular value of nnpfc_id that is a PON-nested SEI message indicated by an SPO SEI message, any associated neural-network post-filter activation SEI messages indicated by the same SPO SEI message with nnpfa_target_id equal to that particular value of nnpfc_id shall also be PON-nested SEI messages.
When a neural-network post-filter activation (NNPFA) SEI message is present with nnpfa_persistence_flag equal to 1 and a particular value of nnpfa_target_id that is not a PON-nested SEI message indicated by an SPO SEI message, the next picture in output order in the same CLVS that has an NNPFA SEI message with the same value of nnpfa_target_id (if any) indicated by the same SPO SEI message shall not have an associated NNPFA SEI message that is a PON-nested SEI message.
When a film grain characteristics SEI message is present with fg_characteristics_persistence_flag equal to 1 that is not a PON-nested SEI message indicated by an SPO SEI message, there shall not be an associated film grain characteristics SEI message indicated by the same SPO SEI message in the same CLVS that is a PON-nested SEI message.
When a frame packing arrangement SEI message is present with fp_arrangement_persistence_flag equal to 1 that is not a PON-nested SEI message indicated by an SPO SEI message, there shall not be an associated frame packing arrangement SEI message indicated by the same SPO SEI message in the same CLVS with fp_arrangement_cancel_flag equal to 1 or the same value of fp_arrangement_id that is a PON-nested SEI message.
When a content colour volume SEI message is present with ccv_persistence_flag equal to 1 that is not a PON-nested SEI message indicated by an SPO SEI message, there shall not be an associated frame packing arrangement SEI message indicated by the same SPO SEI message in the same CLVS that is a PON-nested SEI message.
When an equirectangular projection SEI message is present with erp_persistence_flag equal to 1 that is not a PON-nested SEI message indicated by an SPO SEI message, there shall not be an associated equirectangular projection SEI message indicated by the same SPO SEI message in the same CLVS that is a PON-nested SEI message.
When a region-wise packing SEI message is present with rwp_persistence_flag equal to 1 that is not a PON-nested SEI message indicated by an SPO SEI message, there shall not be an associated region-wise packing SEI message indicated by the same SPO SEI message in the same CLVS that is a PON-nested SEI message.
When a sample aspect ratio SEI message is present with sari_persistence_flag equal to 1 that is not a PON-nested SEI message indicated by an SPO SEI message, there shall not be an associated sample aspect ratio SEI message indicated by the same SPO SEI message in the same CLVS that is a PON-nested SEI message.
When an annotated regions SEI message is present that is not a PON-nested SEI message indicated by an SPO SEI message, there shall not be an associated annotated regions SEI message indicated by the same SPO SEI message in the same CLVS that is a PON-nested SEI message.
When an alpha channel information SEI message is present that is not a PON-nested SEI message indicated by an SPO SEI message, there shall not be an associated alpha channel information SEI message indicated by the same SPO SEI message in the same CLVS that is a PON-nested SEI message.
When a display orientation SEI message is present that is not a PON-nested SEI message indicated by an SPO SEI message, there shall not be an associated display orientation SEI message indicated by the same SPO SEI message in the same CLVS that is a PON-nested SEI message.
When a colour transform indication SEI message is present with colour_transform persistence_flag equal to 1 that is not a PON-nested SEI message indicated by an SPO SEI message, there shall not be an associated colour transform indication SEI message indicated by the same SPO SEI message in the same CLVS with colour_transform_cancel_flag equal to 1 or the same value of colour_transform id that is a PON-nested SEI message.

When multiple FGC SEI messages are indicated in an SPO SEI message, video decoder 300 and/or post processing unit 124 may apply an alternative FGC to a picture based on the picture resolution if the processing order of the FGC SEI messages are the same. If the processing order is different, the prefix indication, po_sei_prefix_data_bit, may include an FGC SEI message extension syntax elements to differentiate the FGC SEI message type. Per this disclosure, video encoder 200, video decoder 300, and/or post processing unit 124 may be configured such that the values of the processing order are the same for SEI messages with a particular SEI payloadType, such as FGC SEI message, when more than one particular SEI messages are indicated by an SPO SEI message. Video decoder 300 and/or post processing unit 124 may apply the corresponding FGC SEI message with the intended picture resolution specified in the FGC extension matching the decoded picture resolution or the picture resolution from previous process.

Furthermore, multiple PON-nested FGC SEI messages may be encapsulated in a single PON SEI message to support multiple spatial resolutions or dynamic picture resolution changes. To prevent the prefix data from spanning the entire FGC SEI message with extensions when processing orders differ, video encoder 200, video decoder 300, and/or post processing unit 124 may be configured to operate according to a requirement of bitstream conformance that the pon_processing_order of multiple PON-nested FGC SEI messages within a PON SEI message shall be the same.

In some examples, additionally or alternatively, video encoder 200, video decoder 300, and/or post processing unit 124 may be configured to use an SPO syntax element that indicates the position of one or more particular syntax elements of an SEI message, where the values of one or more particular syntax elements are used to differentiate the SEI messages indicated in an SPO SEI message. The number of bits of one or more particular syntax elements and the values of one or more particular syntax elements may be included in the SPO SEI message.

In some examples, additionally or alternatively, video encoder 200, video decoder 300, and/or post processing unit 124 may be configured to process a prefix extension structure at the beginning of a high-level syntax structure. The prefix extension structure may specify a prefix extension flag, the number of prefix extension bits for future proofing. The prefix extension flag may be equal to 0 for the base codec, and may be equal to 1 for the codec extensions. Video decoder 300 and/or post processing unit 124 may parse the prefix extension syntax elements when the prefix extension flag is equal to 1. Such a prefix extension may be as in the following table, where [added: “ ”] indicates added elements relative to the existing FGC SEI message:

TABLE 1

| | Descriptor |
|---|---|
| film_grain_characteristics( payloadSize ) { | |
| [added: “prefix_extension_flag”] | u(1) |
| [added: “if(prefix_extension_flag) {“] | |
| [added: “num_prefix_extension_bits”] | ue(v) |
| while(num_prefix_extension_bits) | |
| [added: “prefix_extension_data_bit”] | u(1) |
| [added: “}”] | |
| fg_characteristics_cancel_flag | u(1) |
| if( !fg_characteristics_cancel_flag ) { | |
| fg_model_id | u(2) |
| ... | |
| } | |

Semantics for the added syntax elements as shown above may be as follows: prefix_extension_flag equal to 0 specifies that no prefix extension syntax structure is present. prefix_extension_flag equal to 1 specifies that the prefix extension syntax structure is present in the Raw Byte Sequence Payload (RBSP) syntax structure.
num_prefix_extension_bit indicates the number of bit present in the prefix extension structure.
prefix_extension_data_bit may have any value. Decoders conforming to a certain profile shall ignore all prefix_extension_data_bit syntax elements.

Additionally or alternatively, video encoder 200, video decoder 300, and/or post processing unit 124 may be configured to process a resolution nesting SEI message including syntax elements per techniques of this disclosure. One or multiple resolutions may be indicated in the resolution nesting SEI message, and each resolution may be associated with one or more SEI messages. An example resolution nesting SEI message may be as follows, where [added: “ ”] indicates added elements relative to the existing FGC SEI message and [removed: “ ”] represents elements removed from the existing FGC SEI message:

TABLE 2

| | Descriptor |
|---|---|
| resolution_nesting( payloadSize ) { | |
| [added:“rn_num_resolutions_minus1”] | u(8) |
| [added:“for( i = 0; i < rn_num_resolutions_minus1 + 1; i++ ) {”] | |
| rn_pic_width_in_luma_samples[added:“[ i ]”] | u(16) |
| rn_pic_height_in_luma_samples[added:“[ i ]”] | u(16) |
| rn_resample_uncropped_picture_flag[added:“[ i ]”] | u(1) |
| if (rn_resample_uncropped_picture_flag[added:“[ i ]”]) { | |
| rn_post_resample_conformance_window_present_flag[added:“[ i ]”] | u(1) |
| [removed:“rn_alignment_zero_6bits”] | u(6) |
| if (rn_post_resample_conformance_window_present_flag[added:“[ i ]”] ) | |
| { | |
| rn_conf_win_left_offset[added:“[ i ]”] | u(16) |
| rn_conf_win_right_offset[added:“[ i ]”] | u(16) |
| rn_conf_win_top_offset[added:“[ i ]”] | u(16) |
| rn_conf_win_bottom_offset[added:“[ i ]”] | u(16) |
| } [symbol] | |
| [removed:“rn_alignment_zero_7bits”] | [symbol] |
| [added:“}”] | |
| rn_num_seis_minus1 | u(8) |
| for( i = 0; i <= rn_num_seis_minus1; i++ ) { | |
| [added:“rn_num_resolutions_for_sei_message[ i ]”] | u(8) |
| [added:“for(j = 0; j < rn_num_resolutions_for_sei_message[ i ]; j++ )”] | |
| [added:“rn_sei_resolution_idx[ i ][ j ]”] | u(8) |
| sei_rn_nested_message( ) | |
| } | |
| } | |

Semantics for the added and modified syntax elements discussed above may be as follows:
rn_num_resolutions_minus1 plus 1 specifies the number of picture resolutions specified in the resolution nesting SEI message.
rn_pic_width_in_luma_samples [i] specifies the i-th picture resolution width in luma samples at which the resolution-nested SEI messages are to be applied.

It is a requirement of bitstream conformance that
rn_pic_width_in_luma_samples is greater than or equal to
pps_pic_width_in_luma_samples.
rn_pic_height_in_luma_samples [i] specifies the i-th picture resolution height in luma samples at which the resolution-nested SEI messages are to be applied.
It is a requirement of bitstream conformance that
rn_pic_height_in_luma_samples is greater than or equal to
pps_pic_height_in_luma_samples.
rn_resample_uncropped_picture_flag [i] equal to 0 specifies that the nested SEI is to be applied to the result of resampling the i-th cropped decoded picture resolution. rn_resample_uncropped picture_flag equal to 1 specifies that the resolution-nested SEI messages are to be applied to the result of resampling the i-th uncropped decoded picture.
rn_post_resample_conformance_window_present_flag [i] equal to 0 specifies that the RN SEI message does not contain additional conformance window offsets. rn_post_resample_conformance_window_present_flag [i] equal to 1 specifies that the RN SEI message does contain additional conformance window offsets to be applied to the resampled picture sample array.
rn_conf_win_left_offset [i], rn_conf_win_right_offset [i], rn_conf_win_top_offset [i], and rn_conf_win_bottom_offset [i] specify the offsets of the conformance windows that is applied to the samples of the i-th resampled pictures resolution in the CLVS that are output from the decoding process and resampled, in terms of a rectangular region specified in picture coordinates for output. It is requirement of bitstream conformance that two RN SEIs in a CLVS (i.e. referring to the same SPS) with equal values of rn_pic_width_in_luma_samples [i] and rn_pic_height_in_luma_samples [i], respectively, the two RN SEIs shall have equal values of rn_conf_win_left_offset [i], rn_conf_win_right_offset [i], rn_conf_win_top_offset [i], and rn_conf_win_bottom_offset [i], respectively. The value of SubWidthC*(rn_conf_win_left_offset [i]+rn_conf_win_right_offset [i]) shall be less than rn_pic_width_in_luma_samples [i], and the value of SubHeightC*(rn_conf_win_top_offset [i]+rn_conf_win_bottom_offset [i]) shall be less than rn_pic_height_in_luma_samples [i].
rn_num_seis_minus1 plus 1 specifies the number of resolution-nested SEI messages.
rn_num_resolutions_for_sei_message [i] specifies the number of resolutions to which the i-th resolution-nested SEI message is associated. The value of rn_num_resolutions_for_sei_message [i] shall be in the range of 0 to rn num_resolutions+1, inclusive. When rn_num_resolutions_for_sei_message [i] is equal to 0, the i-th resolution-nested SEI message applies to all the resolutions specified in the resolution nesting SEI message.
rn_sei_resolution_idx [i] [j] specifies the index, into the list of resolutions specified in the resolution nesting SEI message, of the j-th resolution to which the i-th resolution-nested SEI message in the resolution nesting SEI message is associated. The value of rn_sei_resolution_idx [i] [j] shall be in the range of 0 to rn_num_resolution_minus1, inclusive.

As an alternative, an identifier (e.g., “rn_id”) representing the resolution nesting SEI message may be added to identify the purpose of the one or more SEI messages that are resolution-nested in the resolution nesting SEI message. The value of rn_id may be in the range of 0 to 216-1, inclusive.

Video encoder 200, video decoder 300, and/or post processing unit 124 may be configured according to a constraint that an i-th resolution indicated by syntax elements rn_pic_width_in_luma_samples [i] and rn_pic_height_in_luma_samples [i], and a j-th resolution indicated by resolution indicated by syntax element rn_pic_width_in_luma_samples [j] and rn_pic_height_in_luma_samples [j], shall be different from each other in the resolution nesting SEI message, for i and j in the range of 0 to rn_num_resolutions_minus1, inclusive. Thus, if there are two distinct syntax elements for signaling width and height for a picture resolution, then those syntax elements may have different values.

Additionally or alternatively, video encoder 200, video decoder 300, and/or post processing unit 124 may be configured according to a constraint that resolution-nested SEI messages that have different payloadType values are to be considered different types of SEI messages. Furthermore, resolution-nested SEI messages that have the same payloadType value but are differentiated by values of syntax elements in the SEI payload sent as SEI message within a resolution nesting SEI message may be considered different types of SEI messages. Additionally, resolution-nested SEI messages that have the same payloadType value and same values of syntax elements in the SEI payload but are differentiated by the associated picture resolution may be consider different types of SEI messages. The types of SEI messages indicated in an resolution nesting SEI message may be different from each other.

In some examples, when a resolution nested FGC SEI message, FGC-A, indicates the picture resolution in its extension, video encoder 200, video decoder 300, and/or post processing unit 124 may be configured such that the value of fg_pic_width_in_luma_samples is equal to the value of rn_pic_width_in_luma_samples [i], and the value of fg_pic_height_in_luma_samples is equal to the value of rn_pic_height_in_luma_samples [i], where i is from 0 to rn num resolutions_minus1. In some examples, additionally or alternatively, when a resolution nested FGC SEI message indicates a picture resolution in its extension, video encoder 200, video decoder 300, and/or post processing unit 124 may be configured such that the value of fg_pic_width_in_luma_samples is equal to the value of rn_pic_width_in_luma_samples, and the value of fg_pic_height_in_luma_samples is equal to the value of rn_pic_height_in_luma_samples.

In some examples, when a resolution nested FGC SEI message, FGC-A, indicates the picture resolution in its extension, video encoder 200, video decoder 300, and/or post processing unit 124 may be configured such that the value of fg_pic_width_in_luma_samples is equal to the value of rn_pic_width_in_luma_samples [i], and the value of fg_pic_height_in_luma_samples is equal to the value of rn_pic_width_in_luma_samples [i], where i is from 0 to rn_num_resolutions_minus1.

In some examples, additionally or alternatively, when a resolution nested FGC SEI message indicates a picture resolution in its extension, video encoder 200, video decoder 300, and/or post processing unit 124 may be configured such that the value of fg_pic_width_in_luma_samples is equal to the value of rn pic_width_in_luma_samples, and the value of fg_pic_height_in_luma_samples is equal to the value of rn_pic_width_in_luma_samples.

When a resolution nesting SEI message is indicated in a SEI message processing order (SPO) SEI message, all resolution nested SEI messages may share the same processing order as the processing order of the resolution nesting SEI message indicated by the SPO SEI message.

Additionally or alternatively, in some examples, video encoder 200, video decoder 300, and/or post processing unit 124 may be configured such that semantics and effects of an SEI message that is not a PON-nested SEI message or a resolution-nested SEI message do not depend on any PON-nested SEI message or resolution-nested SEI message in the same processing chain.

Additionally or alternatively, in some examples, video encoder 200, video decoder 300, and/or post processing unit 124 may be configured such that the semantics and effect of an SEI message indicated by an SPO SEI message that is not a PON-nested SEI message or a resolution-nested SEI message do not depend on any PON-nested SEI message or resolution-nested SEI message indicated by the same SPO SEI message.

Ultimately, post processing unit 124 may receive one or more SEI messages related to post processing decoded video data, as well as the decoded video data, from video decoder 300. Post processing unit 124 may perform one or more post processing tasks to the video data according to the SEI messages. For example, if one of the SEI messages includes film grain characteristics, post processing unit 124 may use the film grain characteristics to apply film grain to the decoded video data. Per elements of the FGC SEI message, post processing unit 124 may determine whether the video data needs to be upsampled (e.g., increased to a higher resolution), and if so, whether the film grain is to be added to the video data before or after the upsampling. Various SEI messages of the bitstream may apply to different resolutions of video data for the bitstream.

In accordance with techniques of this disclosure, post processing unit 124 processes video data, e.g., video data decoded by video decoder 300. Post processing unit 124 may obtain (e.g., receive) a non-processing order nesting (PON)-nested supplemental enhancement information (SEI) message in a bitstream for a processing chain to be performed on video data of the bitstream. Post processing unit 124 may also obtain a PON-nested SEI message in the bitstream for the processing chain. Post processing unit 124 may then perform the processing chain on the video data to form post-processed video data. Performing the processing chain on the video data to form post-processed video data may include using contents of the non-PON-nested SEI message to perform one or more processing tasks of the processing chain without modifying the one or more processing tasks based on contents of the PON-nested SEI message.

As discussed above, a requirement of bitstream conformance as imposed by a standard, such as ITU-T H.274, may specify that, for any two SEI messages seiMsgA and seiMsgB associated with the same processing chain, where seiMsgA is not PON-nested and seiMsgB is a PON-nested SEI message, seiMsgB does not affect semantics and effects of seiMsgA. For example, seiMsgB does not cancel persistence of seiMsgA. The PON-nested SEI message includes data canceling persistence of one or more SEI messages. Accordingly, in such a circumstance, post processing unit 124 may maintain persistence of a non-PON-nested SEI message for a processing chain even if a PON-nested SEI message for the processing chain indicates that persistence is to be canceled.

The non-PON-nested SEI message may be a non-PON-nested film grain characteristic (FGC) SEI message for a first spatial resolution. Thus, the PON-nested SEI message may be a PON-nested FGC SEI message for a second spatial resolution different than the first resolution.

The non-PON-nested FGC SEI message may include data indicating that film grain characteristics are to be persistent.

The one or more processing tasks to be performed as part of the processing chain may include applying film grain to the video data. The data indicating that film grain characteristics are to be persistent may be a fg_characteristics_persistence_flag having a value of 1.

The non-PON-nested FGC SEI message may include data indicating whether a prefix extension syntax structure is included in the FGC SEI message. When the data indicates that the non-PON-nested FGC SEI message includes the prefix extension syntax structure, the non-PON-nested FGC SEI message may include a number of prefix extension bits and prefix extension data for each of the prefix extension bits.

Post processing unit 124 may process a processing order nesting (PON)-nested neural-network post-filter characteristics SEI message having a value for a neural-network post-filter characteristics identifier (nnpfc_id). Post processing unit 124 may process a PON-nested neural-network post-filter activation SEI message having the same value for the nnpfc_id.

Post processing unit 124 may process a first non-PON-nested neural-network post-filter activation SEI message including data representative of persistence for the neural-network post-filter activation SEI message and data including a neural-network post-filter activation target identifier (nnpfa_target_id). The first non-PON-nested neural-network post-filter activation SEI message may be indicated by an SEI processing order (SPO) SEI message. Post processing unit 124 may process a second non-PON-nested neural-network post-filter activation SEI message including the nnpfa_target_id. The second non-PON-nested neural-network post-filter activation SEI message may also be indicated by the SPO SEI message. The second non-PON-nested neural-network post-filter activation SEI message need not have an associated NNPFA SEI message that is a PON-nested SEI message.

The non-PON-nested SEI message may be one of a frame packing arrangement SEI message, a content colour volume SEI message, an equirectangular projection SEI message, a region-wise packing SEI message, a sample aspect ratio SEI message, an annotated regions SEI message, an alpha channel information SEI message, a display orientation SEI message, or a colour transform indication SEI message indicated by an SPO SEI message.

One or more nested SEI messages may be nested in a processing order nesting (PON) SEI message. An SEI processing order (SPO) SEI message may include data indicating the non-PON-nested SEI message. The bitstream may further include a nested SEI message indicated by the SPO SEI message. The nested SEI message may include data for the post processing process. Alternatively, the bitstream need not include any nested SEI message including data for the post processing process.

Post processing unit 124 may process a resolution nesting SEI message. Processing the resolution nesting SEI message may include processing data representing a number of resolutions signaled in the resolution nesting SEI message. For each of the number of resolutions, post processing unit 124 may process data representing a respective picture width, a respective picture height, and whether a nested SEI message is to be applied to resampling of a picture. For each of a number of nested SEI messages, post processing unit 124 may process a number of resolutions for the nested SEI message. For each of the number of resolutions, post processing unit 124 may process a resolution index value.

By using the specific arrangement of post processing unit 124 operating according to a requirement of bitstream conformance that, for any two SEI messages seiMsgA and seiMsgB associated with the same processing chain, where seiMsgA is not PON-nested and seiMsgB is a PON-nested SEI message, the semantics and effect of seiMsgA are not affected by seiMsgB, system 100 may achieve various technical advantages. For example, preventing seiMsgB from cancelling the persistence of seiMsgA may allow a single bitstream to carry the non-PON-nested SEI message and the PON-nested SEI message simultaneously, without conflict.

The ability to carry the non-PON-nested SEI message and the PON-nested SEI message in the single bitstream may support backward compatibility with traditional decoders that do not recognize processing order nesting, while simultaneously supporting newer decoders capable of aligning film grain characteristics with specific picture resolutions. Supporting traditional decoders and newer decoders with the single bitstream may reduce bandwidth requirements and improve overall coding efficiency. Furthermore, applying resolution-specific film grain parameters rather than upsampling film grain parameters intended for different resolutions may prevent degraded visual quality, thereby providing superior subjective video quality across a diverse range of destination devices.

In this manner, video encoder 200 may generate a bitstream including encoded video data, e.g., syntax elements describing partitioning of a picture into blocks (e.g., CUs) and prediction and/or residual information for the blocks. Video encoder 200 may further generate the bitstream to include one or more SEI messages as discussed above. Ultimately, video decoder 300 may receive the bitstream and decode the encoded video data. Likewise, video decoder 300 may parse one or more of the SEI messages and associate an appropriate SEI message with an appropriate resolution for the video data, e.g., to correctly determine FGC parameters for post processing the video data at the appropriate resolution.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs to exploit cross-component correlations. Different color components may share the same filters (including network structure and model parameters) or each component may have its own specific filters.

The filtering process can also be generalized as follows:

R′(i,j)=R(i,j)+NN_filter_residual_ouput(R)

Here, R (i, j) represents a reconstructed sample at position (i, j) in the picture, R′(i, j) represents the filtered version of the reconstructed sample, and NN_filter_residual_output (R) represents the intermediate samples discussed above that are calculated by the NN filter. The model structure and model parameters of NN-based filter(s) can be pre-defined and be stored at video encoder 200 and video decoder 300. The filters can also be signaled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PRELU layer is an activation function used in neural networks, and is a variant of the ReLU (Rectified Linear Unit) activation function. As described above, the convolution layer outputs feature maps, each corresponding to one filter, representing detected features in the input. Following the convolution layer, the PRELU layer applies the PRELU activation function to each element of the feature maps produced by the convolution layer. For positive values, the PRELU layer acts like a standard ReLU, passing the value through. For negative values, instead of setting them to zero (e.g., as ReLU does), the PRELU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a frame, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g. for 4:2:0 representation, or can be up-sampled to the Luma resolution to achieve per-pixel representation. Similarly, QP, BS, partitioning, or coding mode information can be provided at lower resolution, including cases with a single value per frame, slice or processing block (e.g. QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bit-stream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In this manner, destination device 116 and post processing unit 124 represent examples of devices for processing video data, including: a memory configured to store video data; and a processing system implemented in circuitry and configured to: obtain a non-processing order nesting (PON)-nested supplemental enhancement information (SEI) message in a bitstream for a processing chain to be performed on video data of the bitstream; obtain a PON-nested SEI message in the bitstream for the processing chain; and perform the processing chain on the video data to form post-processed video data, wherein the processing system is configured to use contents of the non-PON-nested SEI message to perform one or more processing tasks of the processing chain without modifying the one or more processing tasks based on contents of the PON-nested SEI message.

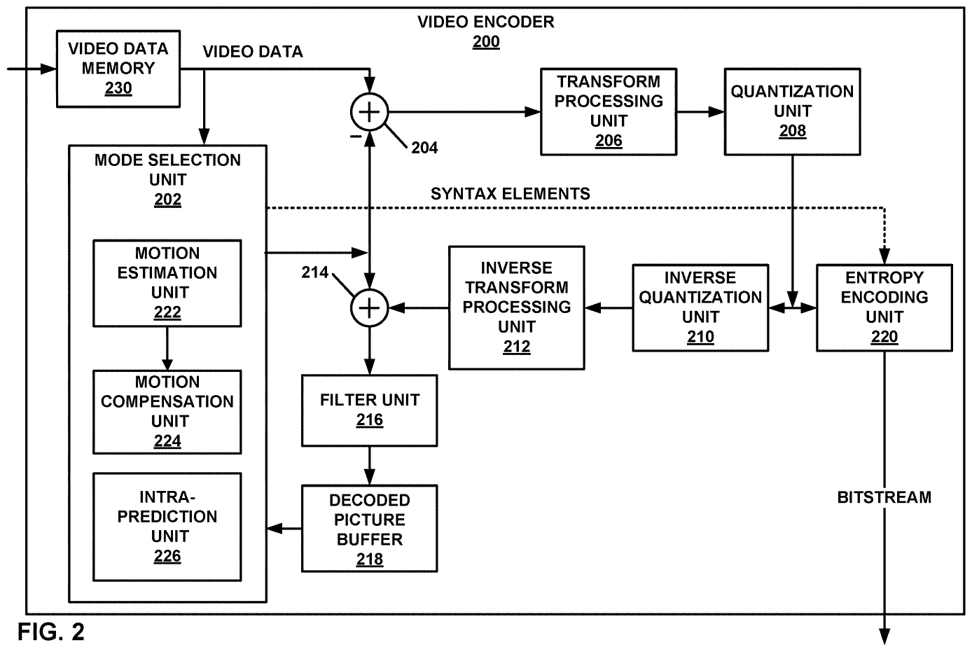

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266) and HEVC (ITU-T H.265). However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUS, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2NxnU, 2NxnD, nLx2N, and nRx2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 may also encode one or more SEI messages per any of the various techniques of this disclosure, alone or in any combination.

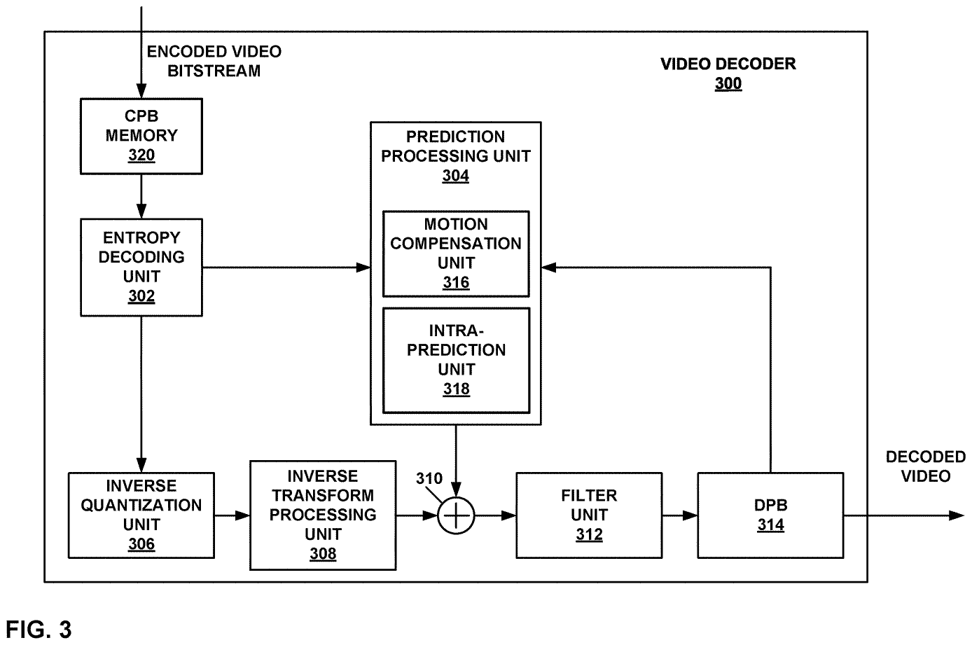

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC (ITU-T H.266) and HEVC (ITU-T H.265). However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may each be provided by the same memory device or separate memory devices or memory units. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

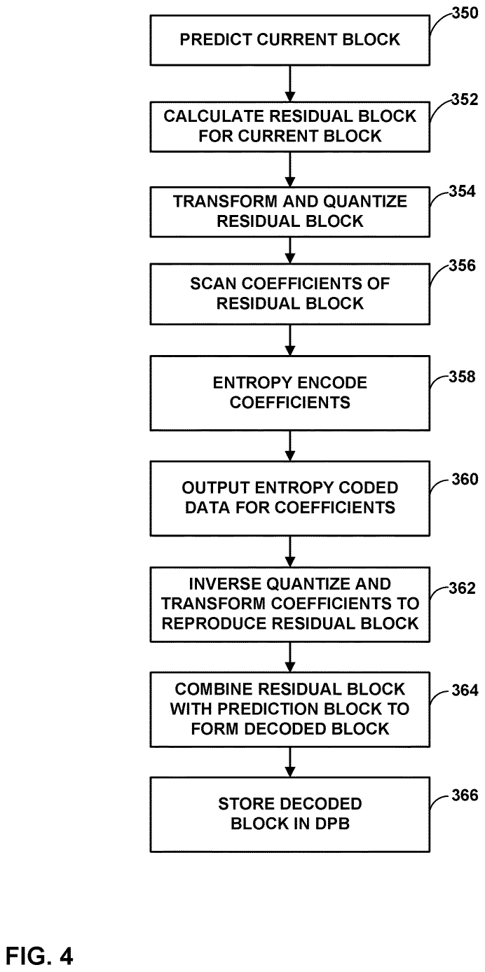

FIG. 4 is a flowchart illustrating an example method for encoding a current block in accordance with the techniques of this disclosure. The current block may include a current CU. Although described with respect to video encoder 200 (FIGS. 1 and 2), it should be understood that other devices may be configured to perform a method similar to that of FIG. 4.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then store the decoded block in DPB 218 (366).

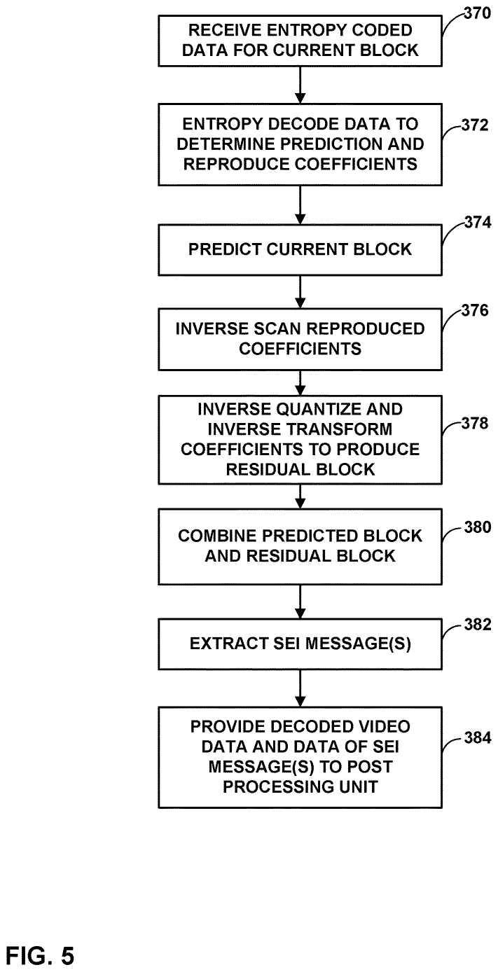

FIG. 5 is a flowchart illustrating an example method for decoding a current block of video data in accordance with the techniques of this disclosure. The current block may include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

Per techniques of this disclosure, video decoder 300 may also extract one or more SEI messages from a bitstream including the current block and other video data (382). For example, video decoder 300 may extract a non-nested SEI message that does not depend on data of any nested SEI messages. Video decoder 300 may then provide the decoded video data and the extracted SEI message(s) to post processing unit 124 of FIG. 1 (384). Post processing unit 124 may then use data of the SEI messages to post process the decoded video data, e.g., apply simulated film grain to the decoded video data.

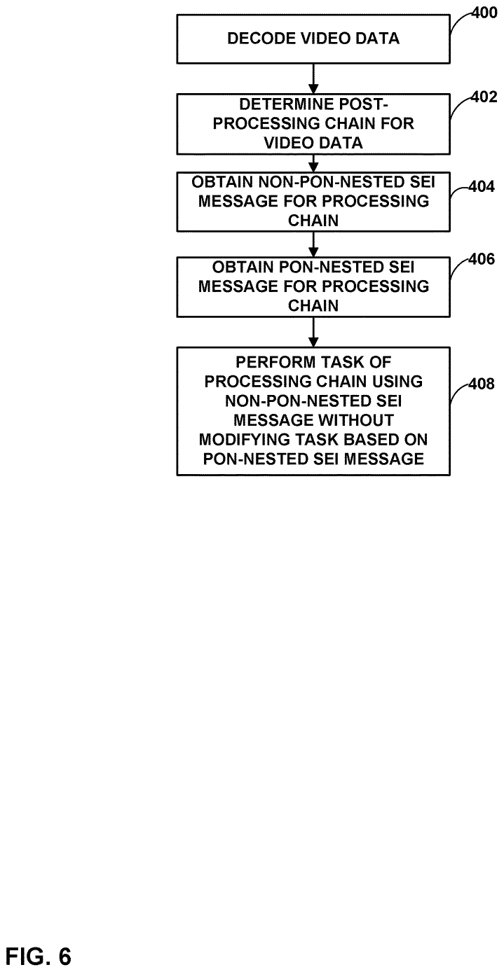

FIG. 6 is a flowchart illustrating an example method of performing post-processing on decoded video data per techniques of this disclosure. The method of FIG. 6 is described with respect to video decoder 300 and post processing unit 124 of FIG. 1.

Initially, video decoder 300 decodes video data to form decoded video data (400). Video decoder 300 provides the decoded video data to post processing unit 124, along with any received SEI messages. Post processing unit 124 may determine a post-processing chain for the video data (402).

Post processing unit 124 obtains a non-processing order nesting (PON)-nested supplemental enhancement information (SEI) message from video decoder 300 for the processing chain to be performed on the decoded video data (404). Post processing unit 124 also obtains a PON-nested SEI message from video decoder 300 for the processing chain (406). That is, video decoder 300 may receive a bitstream including encoded video data, the non-PON-nested SEI message, and the PON-nested SEI message, and provide decoded video data, the non-PON-nested SEI message, and the PON-nested SEI message to post processing unit 124.

Post processing unit 124 performs the processing chain on the video data to form post-processed video data. To perform the processing chain, post processing unit 124 uses contents of the non-PON-nested SEI message to perform one or more processing tasks of the processing chain without modifying the one or more processing tasks based on contents of the PON-nested SEI message (408).

In some examples, the PON-nested SEI message includes data canceling persistence of one or more SEI messages. However, per techniques of this disclosure, post processing unit 124 may nevertheless maintain persistence of the non-PON-nested SEI message.

The one or more processing tasks may include applying film grain to the video data. In such a case, the non-PON-nested SEI message may be a non-PON-nested film grain characteristic (FGC) SEI message for a first spatial resolution of the video data. The PON-nested SEI message may be a PON-nested FGC SEI message for a second spatial resolution different than the first resolution. The non-PON-nested FGC SEI message may include data indicating that film grain characteristics are to be persistent. For example, the data indicating that film grain characteristics are to be persistent may be a fg_characteristics_persistence_flag having a value of 1.

The non-PON-nested FGC SEI message may include data indicating whether a prefix extension syntax structure is included in the FGC SEI message. When the data indicates that the non-PON-nested FGC SEI message includes the prefix extension syntax structure, the non-PON-nested FGC SEI message includes a number of prefix extension bits and prefix extension data for each of the prefix extension bits.

In some examples, post processing unit 124 processes a PON-nested neural-network post-filter characteristics SEI message having a value for a neural-network post-filter characteristics identifier (nnpfc_id). Post processing unit 124 may process a PON-nested neural-network post-filter activation SEI message having the same value for the nnpfc_id.

In some examples, post processing unit 124 processes a first non-PON-nested neural-network post-filter activation SEI message including data representative of persistence for the neural-network post-filter activation SEI message and data including a neural-network post-filter activation target identifier (nnpfa_target_id). The first non-PON-nested neural-network post-filter activation SEI message may be indicated by an SEI processing order (SPO) SEI message. Post processing unit 124 may process a second non-PON-nested neural-network post-filter activation SEI message including the nnpfa_target_id. The second non-PON-nested neural-network post-filter activation SEI message may be indicated by the SPO SEI message. The second non-PON-nested neural-network post-filter activation SEI message need not have an associated NNPFA SEI message that is a PON-nested SEI message.

In some examples, the non-PON-nested SEI message may be one of a frame packing arrangement SEI message, a content colour volume SEI message, an equirectangular projection SEI message, a region-wise packing SEI message, a sample aspect ratio SEI message, an annotated regions SEI message, an alpha channel information SEI message, a display orientation SEI message, or a colour transform indication SEI message indicated by an SPO SEI message.

In this manner, the method of FIG. 6 represents an example of a method of processing video data, including: obtaining a non-processing order nesting (PON)-nested supplemental enhancement information (SEI) message in a bitstream for a processing chain to be performed on video data of the bitstream; obtaining a PON-nested SEI message in the bitstream for the processing chain; and performing the processing chain on the video data to form post-processed video data, including using contents of the non-PON-nested SEI message to perform one or more processing tasks of the processing chain without modifying the one or more processing tasks based on contents of the PON-nested SEI message.

The following clauses represent various examples of the techniques of this disclosure:

Clause 1. A method of processing video data, the method comprising: processing a non-nested supplemental enhancement information (SEI) message of a bitstream, the non-nested SEI message including post processing data for performing a post processing process on video data of the bitstream, wherein the non-nested SEI message does not depend on any nested SEI message.

Clause 2. The method of clause 1, wherein the post processing process comprises applying film grain to the video data and the non-nested SEI message comprises a non-nested film grain characteristic (FGC) SEI message.

Clause 3. The method of clause 2, wherein the non-nested FGC SEI message includes data indicating that film grain characteristics are to be persistent.

Clause 4. The method of clause 3, wherein the data indicating that film grain characteristics are to be persistent comprises a fg_characteristics_persistence_flag having a value of 1.

Clause 5. The method of any of clauses 2-4, wherein the non-nested FGC SEI message includes data indicating whether a prefix extension syntax structure is included in the FGC SEI message, when the data indicates that the non-nested FGC SEI message includes the prefix extension syntax structure, a number of prefix extension bits and prefix extension data for each of the prefix extension bits.

Clause 6. The method of any of clauses 1-5, further comprising: processing a processing order nesting (PON)-nested neural-network post-filter characteristics SEI message having a value for a neural-network post-filter characteristics identifier (nnpfc_id); and processing a PON-nested neural-network post-filter activation SEI message having the value for the nnpfc_id.

Clause 7. The method of any of clauses 1-6, further comprising: processing a first non-PON-nested neural-network post-filter activation SEI message including data representative of persistence for the neural-network post-filter activation SEI message and data including a neural-network post-filter activation target identifier (nnpfa_target_id), the first non-PON-nested neural-network post-filter activation SEI message being indicated by an SEI processing order (SPO) SEI message; and processing a second non-PON-nested neural-network post-filter activation SEI message including the nnpfa_target_id, the second non-PON-nested neural-network post-filter activation SEI message being indicated by the SPO SEI message, the second non-PON-nested neural-network post-filter activation SEI message not having an associated NNPFA SEI message that is a PON-nested SEI message.

Clause 8. The method of clause 1, wherein the non-nested SEI message comprises a frame packing arrangement SEI message indicated by an SPO SEI message.

Clause 9. The method of clause 1, wherein the non-nested SEI message comprises a content colour volume SEI message indicated by an SPO SEI message.

Clause 10. The method of clause 1, wherein the non-nested SEI message comprises a content colour volume SEI message indicated by an SPO SEI message.

Clause 11. The method of clause 1, wherein the non-nested SEI message comprises an equirectangular projection SEI message indicated by an SPO SEI message.

Clause 12. The method of clause 1, wherein the non-nested SEI message comprises a region-wise packing SEI message indicated by an SPO SEI message.

Clause 13. The method of clause 1, wherein the non-nested SEI message comprises a sample aspect ratio SEI message indicated by an SPO SEI message.

Clause 14. The method of clause 1, wherein the non-nested SEI message comprises an annotated regions SEI message indicated by an SPO SEI message.

Clause 15. The method of clause 1, wherein the non-nested SEI message comprises an alpha channel information SEI message indicated by an SPO SEI message.

Clause 16. The method of clause 1, wherein the non-nested SEI message comprises a display orientation SEI message indicated by an SPO SEI message.

Clause 17. The method of clause 1, wherein the non-nested SEI message comprises a colour transform indication SEI message indicated by an SPO SEI message.

Clause 18. The method of any of clauses 1-17, wherein one or more nested SEI messages are nested in a processing order nesting (PON) SEI message.

Clause 19. The method of any of clauses 1-18, wherein an SEI processing order (SPO) SEI message includes data indicating the non-nested SEI message.

Clause 20. The method of clause 19, wherein the bitstream further includes a nested SEI message indicated by the SPO SEI message, the nested SEI message including data for the post processing process.

Clause 21. The method of clause 19, wherein the bitstream does not include any nested SEI message including data for the post processing process.

Clause 22. The method of any of clauses 1-21, further comprising processing a resolution nesting SEI message, including: processing data representing a number of resolutions signaled in the resolution nesting SEI message; for each of the number of resolutions, processing data representing a respective picture width, a respective picture height, and whether a nested SEI message is to be applied to resampling of a picture; for each of a number of nested SEI messages: processing a number of resolutions for the nested SEI message; and for each of the number of resolutions, processing a resolution index value.

Clause 23. The method of any of clauses 1-22, further comprising decoding the video data of the bitstream and providing the decoded video data and the non-nested SEI message to a post processing unit.

Clause 24. The method of any of clauses 1-22, further comprising encoding the video data of the bitstream.

Clause 25. A device for processing video data, the device comprising one or more means for performing the method of any of clauses 1-24.

Clause 26. The device of clause 25, further comprising a display configured to display decoded video data.

Clause 27. The device of any of clauses 25 and 26, wherein the device comprises one or more of a camera, a computer, a mobile device, a broadcast receiver device, or a set-top box.

Clause 28. The device of any of clauses 25-27, further comprising a memory configured to store the video data.

Clause 29. A computer-readable storage medium having stored thereon instructions that, when executed, cause a processor of a device for decoding video data to perform the method of any of clauses 1-24.

Clause 30. A device for processing video data, the device comprising: means for processing a non-nested supplemental enhancement information (SEI) message of a bitstream, the non-nested SEI message including post processing data for performing a post processing process on video data of the bitstream, wherein the non-nested SEI message does not depend on any nested SEI message.

Clause 31. A method of processing video data, the method comprising: obtaining a non-processing order nesting (PON)-nested supplemental enhancement information (SEI) message in a bitstream for a processing chain to be performed on video data of the bitstream; obtaining a PON-nested SEI message in the bitstream for the processing chain; and performing the processing chain on the video data to form post-processed video data, including using contents of the non-PON-nested SEI message to perform one or more processing tasks of the processing chain without modifying the one or more processing tasks based on contents of the PON-nested SEI message.

Clause 32. The method of clause 31, wherein the PON-nested SEI message includes data canceling persistence of one or more SEI messages, the method further comprising maintaining persistence of the non-PON-nested SEI message.

Clause 33. The method of clause 32, wherein the non-PON-nested SEI message comprises a non-PON-nested film grain characteristic (FGC) SEI message for a first spatial resolution, and wherein the PON-nested SEI message comprises a PON-nested FGC SEI message for a second spatial resolution different than the first spatial resolution.

Clause 34. The method of clause 33, wherein the non-PON-nested FGC SEI message includes data indicating that film grain characteristics are to be persistent.

Clause 35. The method of clause 31, wherein the one or more processing tasks comprises applying film grain to the video data, and wherein the non-PON-nested SEI message comprises a non-PON-nested film grain characteristic (FGC) SEI message.

Clause 36. The method of clause 35, wherein the non-PON-nested FGC SEI message includes data indicating that film grain characteristics are to be persistent.

Clause 37. The method of clause 36, wherein the data indicating that film grain characteristics are to be persistent comprises a fg_characteristics_persistence_flag having a value of 1.

Clause 38. The method of any of clauses 35-37, wherein the non-PON-nested FGC SEI message includes data indicating whether a prefix extension syntax structure is included in the FGC SEI message, when the data indicates that the non-PON-nested FGC SEI message includes the prefix extension syntax structure, a number of prefix extension bits and prefix extension data for each of the prefix extension bits.

Clause 39. The method of any of clauses 31-38, further comprising: processing a processing order nesting (PON)-nested neural-network post-filter characteristics SEI message having a value for a neural-network post-filter characteristics identifier (nnpfc_id); and processing a PON-nested neural-network post-filter activation SEI message having the value for the nnpfc_id.

Clause 40. The method of any of clauses 31-39, further comprising: processing a first non-PON-nested neural-network post-filter activation SEI message including data representative of persistence for the neural-network post-filter activation SEI message and data including a neural-network post-filter activation target identifier (nnpfa_target_id), the first non-PON-nested neural-network post-filter activation SEI message being indicated by an SEI processing order (SPO) SEI message; and processing a second non-PON-nested neural-network post-filter activation SEI message including the nnpfa_target_id, the second non-PON-nested neural-network post-filter activation SEI message being indicated by the SPO SEI message, the second non-PON-nested neural-network post-filter activation SEI message not having an associated NNPFA SEI message that is a PON-nested SEI message.

Clause 41. The method of clause 31, wherein the non-PON-nested SEI message comprises one of a frame packing arrangement SEI message, a content colour volume SEI message, an equirectangular projection SEI message, a region-wise packing SEI message, a sample aspect ratio SEI message, an annotated regions SEI message, an alpha channel information SEI message, a display orientation SEI message, or a colour transform indication SEI message indicated by an SPO SEI message.

Clause 42. The method of any of clauses 31-41, wherein one or more nested SEI messages are nested in a processing order nesting (PON) SEI message.

Clause 43. The method of any of clauses 31-42, wherein an SEI processing order (SPO) SEI message includes data indicating the non-PON-nested SEI message.

Clause 44. The method of clause 43, wherein the bitstream further includes a nested SEI message indicated by the SPO SEI message, the nested SEI message including data for the post processing process.

Clause 45. The method of clause 43, wherein the bitstream does not include any nested SEI message including data for the post processing process.

Clause 46. The method of any of clauses 31-45, further comprising processing a resolution nesting SEI message, including: processing data representing a number of resolutions signaled in the resolution nesting SEI message; for each of the number of resolutions, processing data representing a respective picture width, a respective picture height, and whether a nested SEI message is to be applied to resampling of a picture; for each of a number of nested SEI messages: processing a number of resolutions for the nested SEI message; and for each of the number of resolutions, processing a resolution index value.

Clause 47. The method of any of clauses 1-46, further comprising decoding the video data of the bitstream and providing the decoded video data and the non-PON-nested SEI message to a post processing unit.

Clause 48. A device for processing video data, the device comprising: a memory configured to store video data; and a processing system implemented in circuitry and configured to: obtain a non-processing order nesting (PON)-nested supplemental enhancement information (SEI) message in a bitstream for a processing chain to be performed on video data of the bitstream; obtain a PON-nested SEI message in the bitstream for the processing chain; and perform the processing chain on the video data to form post-processed video data, wherein the processing system is configured to use contents of the non-PON-nested SEI message to perform one or more processing tasks of the processing chain without modifying the one or more processing tasks based on contents of the PON-nested SEI message.

Clause 49. The device of clause 48, wherein the PON-nested SEI message includes data canceling persistence of one or more SEI messages, and wherein the processing system is configured to maintain persistence of the non-PON-nested SEI message.

Clause 50. The device of clause 49, wherein the non-PON-nested SEI message comprises a non-PON-nested film grain characteristic (FGC) SEI message for a first spatial resolution, and wherein the PON-nested SEI message comprises a PON-nested FGC SEI message for a second spatial resolution different than the first spatial resolution.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
obtaining a non-processing order nesting (PON)-nested supplemental enhancement information (SEI) message in a bitstream for a processing chain to be performed on video data of the bitstream;
obtaining a PON-nested SEI message in the bitstream for the processing chain; and
performing the processing chain on the video data to form post-processed video data, including using contents of the non-PON-nested SEI message to perform one or more processing tasks of the processing chain without modifying the one or more processing tasks based on contents of the PON-nested SEI message.

2. The method of claim 1, wherein the PON-nested SEI message includes data canceling persistence of one or more SEI messages, the method further comprising maintaining persistence of the non-PON-nested SEI message.

3. The method of claim 2, wherein the non-PON-nested SEI message comprises a non-PON-nested film grain characteristic (FGC) SEI message for a first spatial resolution, and wherein the PON-nested SEI message comprises a PON-nested FGC SEI message for a second spatial resolution different than the first spatial resolution.

4. The method of claim 3, wherein the non-PON-nested FGC SEI message includes data indicating that film grain characteristics are to be persistent.

5. The method of claim 1, wherein the one or more processing tasks comprises applying film grain to the video data, and wherein the non-PON-nested SEI message comprises a non-PON-nested film grain characteristic (FGC) SEI message.

6. The method of claim 5, wherein the non-PON-nested FGC SEI message includes data indicating that film grain characteristics are to be persistent.

7. The method of claim 6, wherein the data indicating that film grain characteristics are to be persistent comprises a fg_characteristics_persistence_flag having a value of 1.

8. The method of claim 5, wherein the non-PON-nested FGC SEI message includes data indicating whether a prefix extension syntax structure is included in the non-PON-nested FGC SEI message, and, when the data indicates that the non-PON-nested FGC SEI message includes the prefix extension syntax structure, a number of prefix extension bits and prefix extension data for each of the prefix extension bits.

9. The method of claim 1, further comprising:
processing a processing order nesting (PON)-nested neural-network post-filter characteristics SEI message having a value for a neural-network post-filter characteristics identifier (nnpfc_id); and
processing a PON-nested neural-network post-filter activation SEI message having the value for the nnpfc_id.

10. The method of claim 1, further comprising:
processing a first non-PON-nested neural-network post-filter activation SEI message including data representative of persistence for the first non-PON-nested neural-network post-filter activation SEI message and data including a neural-network post-filter activation target identifier (nnpfa_target_id), the first non-PON-nested neural-network post-filter activation SEI message being indicated by an SEI processing order (SPO) SEI message; and
processing a second non-PON-nested neural-network post-filter activation SEI message including the nnpfa_target_id, the second non-PON-nested neural-network post-filter activation SEI message being indicated by the SPO SEI message, the second non-PON-nested neural-network post-filter activation SEI message not having an associated NNPFA SEI message that is a PON-nested SEI message.

11. The method of claim 1, wherein the non-PON-nested SEI message comprises one of a frame packing arrangement SEI message, a content colour volume SEI message, an equirectangular projection SEI message, a region-wise packing SEI message, a sample aspect ratio SEI message, an annotated regions SEI message, an alpha channel information SEI message, a display orientation SEI message, or a colour transform indication SEI message indicated by an SPO SEI message.

12. The method of claim 1, wherein one or more nested SEI messages are nested in a processing order nesting (PON) SEI message.

13. The method of claim 1, wherein an SEI processing order (SPO) SEI message includes data indicating the non-PON-nested SEI message.

14. The method of claim 13, wherein the bitstream further includes a nested SEI message indicated by the SPO SEI message, the nested SEI message including data for the processing chain.

15. The method of claim 13, wherein the bitstream does not include any nested SEI message including data for the processing chain.

16. The method of claim 1, further comprising processing a resolution nesting SEI message, including:
processing data representing a number of resolutions signaled in the resolution nesting SEI message;
for each of the number of resolutions, processing data representing a respective picture width, a respective picture height, and whether a nested SEI message is to be applied to resampling of a picture;
for each of a number of nested SEI messages:
processing a number of resolutions for the nested SEI message; and
for each of the number of resolutions, processing a resolution index value.

17. The method of claim 1, further comprising:
decoding the video data of the bitstream to form decoded video data; and
providing the decoded video data and the non-PON-nested SEI message to a post processing unit.

18. A device for processing video data, the device comprising:
a memory configured to store video data; and
a processing system implemented in circuitry and configured to:
obtain a non-processing order nesting (PON)-nested supplemental enhancement information (SEI) message in a bitstream for a processing chain to be performed on video data of the bitstream;
obtain a PON-nested SEI message in the bitstream for the processing chain; and
perform the processing chain on the video data to form post-processed video data, wherein the processing system is configured to use contents of the non-PON-nested SEI message to perform one or more processing tasks of the processing chain without modifying the one or more processing tasks based on contents of the PON-nested SEI message.

19. The device of claim 18, wherein the PON-nested SEI message includes data canceling persistence of one or more SEI messages, and wherein the processing system is configured to maintain persistence of the non-PON-nested SEI message.

20. The device of claim 19, wherein the non-PON-nested SEI message comprises a non-PON-nested film grain characteristic (FGC) SEI message for a first spatial resolution, and wherein the PON-nested SEI message comprises a PON-nested FGC SEI message for a second spatial resolution different than the first spatial resolution.
